SEQUENCE LISTING (15 sequences)

SEQ ID NO: 1 - DNA, 30 bp, Artificial Sequence
  Description of Artificial Sequence synthetic DNA
cagtcacgacgttgtaaaacgacggccagt

SEQ ID NO: 2 - DNA, 32 bp, Artificial Sequence
  Description of Artificial Sequence synthetic DNA
gataacaatttcacacaggaaacagctatgac

SEQ ID NO: 3 - DNA, 1469 bp, Lambda virus
gataacaatttcacacaggaaacagctatgaccatgattacgaattcgatatcgcatttttcaccatgctcatcaaagacagtaagataaaacattgtaacaaaggaatagtcattccaaccatctgctcgtaggaatgccttatttttttctactgcaggaatatacccgcctctttcaataacactaaactccaacatatagtaacccttaattttattaaaataaccgcaatttatttggcggcaacacaggatctctcttttaagttactctctattacatacgttttccatctaaaaattagtagtattgaacttaacggggcatcgtattgtagttttccatatttagctttctgcttccttttggataacccactgttattcatgttgcatggtgcactgtttataccaacgatatagtctattaatgcatatatagtatcgccgaacgattagctcttcaggcttctgaagaagcgtttcaagtactaataagccgatagatagccacggacttcgtagccatttttcataagtgttaacttccgctcctcgctcataacagacattcactacagttatggcggaaaggtatgcatgctgggtgtggggaagtcgtgaaagaaaagaagtcagctgcgtcgtttgacatcactgctatcttcttactggttatgcaggtcgtagtgggtggcacacaaagctttgcactggattgcgaggctttgtgcttctctggagtgcgacaggtttgatgacaaaaaattagcgcaagaagacaaaaatcaccttgcgctaatgctctgttacaggtcactaataccatctaagtagttgattcatagtgactgcatatgttgtgttttacagtattatgtagtctgttttttatgcaaaatctaatttaatatattgatatttatatcattttacgtttctcgttcagcttttttatactaagttggcattataaaaaagcattgcttatcaatttgttgcaacgaacaggtcactatcagtcaaaataaaatcattatttgatttcaattttgtcccactccctgcctctgtcatcacgatactgtgatgccatggtgtccgacttatgcccgagaagatgttgagcaaacttatcgcttatctgcttctcatagagtcttgcagacaaactgcgcaactcgtgaaaggtaggcggatccccttcgaaggaaagacctgatgcttttcgtgcgcgcataaaataccttgatactgtgccggatgaaagcggttcgcgacgagtagatgcaattatggtttctccgccaagaatctctttgcatttatcaagtgtttccttcattgatattccgagagcatcaatatgcaatgctgttgggatggcaatttttacgcctgttttgctttgctcgacataaagatatcaagcttggcactggccgtcgttttacaacgtcgtgactg

SEQ ID NO: 4 - DNA, 744 bp, Mus musculus
tgtaaaacgacggccagtgaattgtaatacgactcactatagggcgaattggagctccaccgcggtggcggccgcataacttcgtatagcatacattatacgaagttatggatcaggccaaatcggccgagctcgaattcgtcgacgagtggcgttgagagctcagagcttgctacagggctacagtgctccaaagcccttcaggattcactttggatacagctctttggagcctgccagcaattagaaatctttctctctcacagacaaatcatgactggaattcatcatggagaaaatgtcagccacagagaagaagcatttagcatgtttgagcacggtcatgaaatagtcatcactacatcagtgatgcacattaagcagaatgtagctgtgctcttgtggatgtgctctctcatcctggactggataatcacatggaaggcctgtgcttcactctccctagagaatgatttgcatcagtaggttataatttaggatgtgtaagaattgcctaaaacactgctggaaacttccctaaggctctggatcacacacggagggttgagaaacaactacaagccaaggacccttaaaagatgtggaagcaccggatccggccataagggcctgatccgtcgagggggggcccggtaccagcttttgttccctttagtgagggttaatttcgagcttggcgtaatcatggtcatagctgtttcctgtgtgaaattgttatccgct

SEQ ID NO: 5 - DNA, 2440 bp, Mus musculus
tgtaaaacgacggccagtgaattgtaatacgactcactatagggcgaattggagctccaccgcggtggcggccgcataacttcgtatagcatacattatacgaagttatggatcaggccaaatcggccgagctcgaattcgtcgacgctttttggcgccatggcgcaaagtcgtgttaccgatttctatgcgtgccgtcgccctggccttacgactccgcgggccaagtcgatctgtctcaccccgagccctggtggcctcgtggctcctgcgttcacccggagcagcagccgcaagcgcgcccggcccccagccgaacccgggagtgaccagcccgcgccgctcgcgcgccggaggttacggctgcctggattggactcctgccccagttctctgcctgagcccagttccccagctgagcccagccctccagctgaccctagccctccagctgaccctggctcccccgtttgcccatcccccgtcaagcgaacaaagagtacaactgtttatgttggtcaacagccgggcaagatcccctcagaggactccgtctctgagctccagtcctgcctgaggcgggcacggaagttgggagcccaggcacgggccctgagagcccgagtccaagagaatgctgtggagcctagtaccccagatgccaaggtgcccacagagcaaccatgtgtcgagaaagctcctgcctaccagcgcttccatgctctggctcagcctggtctcccaggccttgtcctaccctacaagtatcaggtgctagttgagatgttccgcagcatggacaccattgtgagcatgctccacaatcgctctgagactgtgacctttgccaaagtcaagcaaggtgttcaggagatgatgcgcaagcgctttgaagagcgcaatgtgggccagatcaaaaccgtgtatcccacgtcgtatcgcttccgccaggagtgcaatgtccccaccttcaaggacagcatcaagagatctgattaccagctcaccatcgagcccttgctgggccaggaggctggcggtgcaacccagctcacagccacgtgcctcctgcagcgccggcaagtcttccggcagaacctggtggaacgtgtcaaggaacagcacaaggtcttcctggcttcactgaacccccccatggcggtgccggacgaccagctgacccgctggcatccgcgcttcaatgtggacgaggtgcctgacattgagccagctgaactgccccagcctcctgtcacagagaagctcaccactgcccaggaagtgctggcccgtgcccggagcttgatgacacccaagatggagaaggccctgagcaacctggccctgcgctcggctgagcccggtagccctgggacctctactccaccactcccggccactccgccagccaccccacctgctgcctctccgagcgccctgaagggtgtgtcccaagcactgctagagcggataagggccaaggaggtccagaagcagctggcaaggatgacacggtgccccgagcaggagcttcgcctgcagcggttagagcgtctgccagagctggcccgcgtgctgcgcaatgtcttcgtgtctgagcggaagccggcactcactatggaggtggtctgtgcaaggatggtggacagttgccaaactgctctgagtccaggggagatggagaaacatctggtgctcctggcagagttgctgccggactggctcagcctgcatcgcatccgcacggatacctacgtcaagctggacaaggctgttgacctggctggcctcactgcgaggctggcccaccacgtccacgccgaggggctgtgactttgagctccttgcctgtttctttcatcagtacacgacgcacttacgcctttaagcctcgccagtgtgggcagctatcgttgcccatggatctcataaagtgctggcattaagttgcttcctgaggctttggggcatcccagactcagctctaggggaagtagactctgaagagtagggtatgttggatggccattgcacaaactactcaagcattaggtatggtcaagacccaagatcaaggtccaggtggaagcctaggctggcatagccttgcttccccatgagacttaagaatcacacagaccttggactttcctgatttcacgggacgctgctctgagagtgaaattgggccttctgtaaatatgtgaagtgtggtttcttttcaaaccttatatggccctgcatgtgactgctagttttggcttttaataaagtcatgtaagatttaaataaaatactactgagatggggatccggccataagggcctgatccgtcgagggggggcccggtaccagcttttgttccctttagtgagggttaatttcgagcttggcgtaatcatggtcatagctgtttcctgtgtgaaattgttatccgct

SEQ ID NO: 6 - DNA, 5460 bp, Mus musculus
tgtaaaacgacggccagtgaattgtaatacgactcactatagggcgaattggagctccaccgcggtggcggccgcataacttcgtatagcatacattatacgaagttatggatcaggccaaatcggccgagctcgaattcgtcgacgagtcgtcaggaccgcttcggctctcggagtaggaagcttggggcgctgggctggtaaggacccgcggcggggcgaagatggagtcctttaccaatgatcggcttcagcttccaaggaatatgatcgaaaacagcatgtttgaagaagagccagatgtggtagatttagccaaagaaccttgtttacatcctctggaacccgatgaagtggaatatgagccccgaggttcgaggcttctggtgcgaggtcttggtgagcatgagatggacgaggatgaagaggattatgagtcctctgcgaagctgctgggcatgtccttcatgaacagaagctcaggcctgcggaacagtgcagcaggctacaggcagagtccagatgggacttgttcattaccctctgccaggaccttagtgatctgtgtttttgtcattgtggttgcggtctctgtaatcatggtgatttatctactgcctagatgtacctttaccaaagaaggctgccacaaaacaaaccagtcagcagaactcatccagccagttgctacaaacgggaaagtgttcccatgggctcaaattaggcttcccactgccattattcctctatgctatgaacttagcctacatccaaacctaacctcaatgacattcaggggatctgtgacaatttcacttcaggctcttcaagacacacgggatatcattctccatagcacaggacataatatttcaagagtgacatttatgtcagctgtttcaagtcaagaaaaacaagttgaaattctggaatatccatatcatgaacaaatcgccgttgttgccccggaacctcttctaacaggacacaattataccctgaagatagagtattcagcaaatatatctaactcttattatgggttttatggcatcacctacacagataaaagtaatgagaaaaagtactttgcagcaactcagtttgaacctctggcagcaagatctgcttttccttgttttgatgaaccagcatttaaggccacatttatcatcaagatcacaaggaatgagcaccatactgcgttatcaaatatgcctaagaagtcatcggtccctgcagaagaaggacttattcaagatgagttttctgaaagtgtgaaaatgagcacatacctggttgctttcattgtaggggagatgaggaacctgagtcaggatgtaaatggaactctggtttctgtgtatgctgtaccagaaaaaattggtcaagttcaccatgccttggacacaactataaagcttcttgagttttatcaaacttactttgaaattcagtacccacttaagaaattggatttggtggccattcctgactttgaagcaggagcaatggaaaactggggcctgcttacattccgagaagagactcttctgtatgacaatgcaacttcttcagtagcagacagaaaactggtcactaaaatcattgctcacgaactggcacatcagtggtttggaaatctggttacaatgcagtggtggaatgacctgtggctaaatgaaggctttgccactttcatggagtatttctctgtggaaaaaatattcaaagagctcaacagttatgaagacttcttagatgctcgatttaaaaccatgaggaaagattccttgaattcgtctcatccaatatcatcatctgttcagtcttcggaacaaatagaagaaatgtttgattctctctcctattttaagggagcttctctcttgttgatgctgaaaagttaccttagtgaagatgtatttcggcatgctgtcattctttacctgcacaatcacagctatgcagctatccaaagtgatgatctctgggacagcttcaatgaggtcacagacaaaactctagatgtaaagaaaatgatgaaaacctggaccctacagaaaggattcccgttagtgacagtccagaggaaggggactgagcttcttctacaacaggaaagattttttctacgcatgcaaccagaaagtcagccttcagatacaagccacctttggcatattccaatatcctatgtcactgatggaagaaactattcagaatatcgatcagtttcactactggacaagaaatcagatgtcatcaatcttacagaacaagtgcagtgggtcaaagtcaattcaaacatgactggctattacattgttcactatgctcatgatgactggacagctctaatcaatcagttaaaaagaaacccttatgttctgagtgacaaagaccgagccaacctgatcaataacatctttgaacttgcaggtcttggcaaagtgcctcttcggatggcatttgatttgattgactatcttaaaaatgagacccacactgcaccgatcactgaagccctgttccagacaaaccttatctataatctcctagaaaaactggggcacatggacctgtcctcaagattggtggccagagtacataaattgctccagaaccaaatccagcagcagacttggacagatgaaggcacaccatccatgcgagagcttcggtcagccttgctggaatttgcctgtgcccacagcctagagaactgtaccactatggccacaaatctgtttgacagttggatggcatcaaatggaactcagagcctgcctactgatgtcatggtcactgtgttcaaggtgggagcgagaaccgagaaaggctggttgttcctctttagcatgtattcctccatgggctctgaagcagaaaagaataaaattcttgaagctcttgccagctcagaggatgtacataaactttactggttaatgaaaagtagccttgatggtgacatcatccgaacacagaagttgtcacttatcattagaacagtgggcagacattttcctggacacttgctggcttgggattttgttaaagaaaactggaataagcttgtacataagttccatctgggctcctataccatacaaagtattgttgctggatctactcacttattttcaacaaagacacatttatctgaggtccaggcattctttgaaaatcagtcagaggcaaccttgaagcttcggtgtgttcaggaggctttggaagtgattcagctgaatatccagtggatggtcaggaatctgaaaacgctctcccagtggctgtagcactcacagctgatctccggcgcccatggctctgctgctttcgcaaaggttgagtgaaggccggcctgctgctgagttgtttgcactgttaggagttctagttagctcagggcccaattgtatttttcatatcttttctgaaatgtctttaggcagtagttatttattacaaaattatattcacctgtatgtcatccatctacaataacaatgaataacttttctttgacacacaaatggagaaaaaagtcagatttgaaattttgttttatttcttagtgtccagagtattactgttacagtgcaaccaaggaaggtctgctgtaagaaccactgtgtttgtaggttgctgattgatcaactgtttgttgctttttgttaaatagatacacctgggtttggtagtgcagtggcaaagacattgaaggtacagctctagacagatgacctgattgggggttctttaaaaaaagttttgtccagtttccagttttttcctgcaaaatagccaggttctaaagactttttcatatttctgttaaattgaacagctgaacagtcaggctcaaagtttcagttttccaaatatttaacactttctgcttcatcttcatgacactatgtaggaagtgttctgaactgagttaacattaattactttactcatgaattccagtacccctaactttgtatcctggtaaggccttccaccagctttctcctgtagaggagcactccatgcttgggaggatttctcctgtagaggagcactccatgccatgcttgggaggatttctgtgagcgctggtggctttgtcattactttcacccaagaatgtaatttgtttaagttgctgtttgaaccttacaaatcataccctcttctctgtgaatcatacccatgtgtgggttttactttatgttacagagtatattagaagcatttcttaaataggatcttcaagaaattaaagctttttattttgaagttcaccataataccttaaaggaataatgagaatgtggagcaggaggaagttgaaaatatggtgggctatgaattctttttttcactgttaaaaacagtgtttttatttagttgaaaaaattacaggttttttgtttgtttgtttgtttgtttatcatggccaaactacgttaaacagagtggccaagaatcaagcagaggacaagggagggagggaacccagagcagaatgtgggcgctttcactccttctgaaggagaaggattgtacttgaactttttgagctatgcagacttattcctagattgttgtgtttctttgaatcttaggagagaagctttcttcttaataactcatgagaagtctatattttgtttgaaaacagtgtctgtgtacataaaaagggaatcactcatttctgaacactgaaaacactccacagagtcagaccatagagaggccacttgtttttattcagctgttgtaaagttagaatatgtggagttatatacaaagttatagtttattttatgagaatatttttatataataaaattttaatggctgacaagctgaaaatagcctgctttaatcctagagtttgctcccaatttcatcttttctaaacagtttttgggtttttgtttgtttgtttgttttttaatttgtgctttttttagtagaaactgttattcctgagaatcatagaatcatctttctattttagtgaaataggtaattatagatctctattccccttgtatttttggtaaatgtctgacagttgtgttgatactgaaggttagtagggttttatatttttagagtgaaggacaaatactcttgtgggttttggttgtcccttttcattttttaccatgctgtattactagattatactttgataacagagtttaacttttgctacttctcaagatcagttcaaccttgagatttacctgcccatctttttgttgatcttatagtctttgtaattctgcatatggcaaatcttgtcctaaataatactttttttccggatccggccataagggcctgatccgtcgagggggggcccggtaccagcttttgttccctttagtgagggttaatttcgagcttggcgtaatcatggtcatagctgtttcctgtgtgaaattgttatccgct

SEQ ID NO: 7 - DNA, 18 bp, Artificial Sequence
  Description of Artificial Sequence synthetic DNA
tgtaaaacgacggccagt

SEQ ID NO: 8 - DNA, 24 bp, Artificial Sequence
  Description of Artificial Sequence synthetic DNA
agcggataacaatttcacacagga

SEQ ID NO: 9 - DNA, 503 bp, Homo sapiens
ccaggggctgctgctgttgctgctgctgagcatgggcggggcatgggcatccagggagccgcttcggccatggtgccaccccatcaatgccatcctggctgtcgagaaggagggctgcccagtgtgcatcaccgtcaacaccaccatctgtgccggctactgccccaccatgatgcgcgtgctgcaggcggtcctgccgcccctgcctcaggtggtgtgcacctaccgtgatgtgcgcttcgagtccatccggctccctggctgcccgcgtggtgtggaccccgtggtctccttccctgtggctctcagctgtcgctgtggaccctgccgccgcagcacctctgactgtgggggtcccaaagaccaccccttgacctgtgaccacccccaactctcaggcctcctcttcctctaaagaccctccccgcagccttccaagtccatcccgactcctggagccctgacaccccgatcctcccacaataaaggcttctcaatccgca

SEQ ID NO: 10 - DNA, 172 bp, Homo sapiens
ccaggggctgctgctgttgctgctgctgagcatgggcggggcatgggcatccagggagccgcttcggccatggtgccaccccatcaatgccatcctggctgtcgagaaggagggctgcccagtgtgcatcaccgtcaacaccaccatctgtgccggctactgccccaccatg

SEQ ID NO: 11 - DNA, 331 bp, Homo sapiens
atgcgcgtgctgcaggcggtcctgccgcccctgcctcaggtggtgtgcacctaccgtgatgtgcgcttcgagtccatccggctccctggctgcccgcgtggtgtggaccccgtggtctccttccctgtggctctcagctgtcgctgtggaccctgccgccgcagcacctctgactgtgggggtcccaaagaccaccccttgacctgtgaccacccccaactctcaggcctcctcttcctctaaagaccctccccgcagccttccaagtccatcccgactcctggagccctgacaccccgatcctcccacaataaaggcttctcaatccgca

SEQ ID NO: 12 - DNA, 19 bp, Artificial Sequence
  Description of Artificial Sequence synthetic DNA
ccaggggctgctgctgttg

SEQ ID NO: 13 - DNA, 30 bp, Artificial Sequence
  Description of Artificial Sequence synthetic DNA
cagcacgcgcatcatggtggggcagtagcc

SEQ ID NO: 14 - DNA, 30 bp, Artificial Sequence
  Description of Artificial Sequence synthetic DNA
tgccccaccatgatgcgcgtgctgcaggcg

SEQ ID NO: 15 - DNA, 23 bp, Artificial Sequence
  Description of Artificial Sequence synthetic DNA
tgcggattgagaagcctttattg

(19) United States
(12) Patent Application Publication
(10) Pub. No.: US 2005/0166782 A2
(43) Pub. Date: Aug. 4, 2005

(54) PRINTED MATERIALS COMPRISING A SUPPORT HAVING AN OLIGOMER AND/OR A POLYMER APPLIED THEREON, A METHOD FOR PREPARING THE SAME AND A METHOD FOR DELIVERING AND/OR STORING THE SAME

(75) Inventor: Yoshihide Hayashizaki, Tsukuba-shi, Ibaraki (JP)

Correspondence Address: DARBY & DARBY P.C., P.O. BOX 5257, NEW YORK, NY, 10150-5257, US

(73) Assignees: Riken, Saitama (JP); KABUSHIKI KAISHA DNAFORM, Minato-ku, Tokyo (JP)

(21) Appl. No.: 10/490,519

(22) Filed: Mar. 23, 2004

(30) Foreign Application Priority Data
Sep. 25, 2001 (JP) 2001-291249

(51) Int. Cl. B41F 1/00

(52) U.S. Cl. 101/494

(57) ABSTRACT

Abstract of the Disclosure

A printed material comprising at least one support having at least one oligomer and/or polymer applied thereon is provided. Also, a method for preparing the printed material and a method for delivering and storing at least one oligomer and/or polymer are provided. The printed materials of the present invention are useful in providing scientists with oligomers and/or polymers of interest from the printed materials easily and immediately.

### Detailed Description of the Invention

### TECHNICAL FIELD

The present invention relates to printed materials comprising a support having an oligomer and/or polymer applied thereon, a method for preparing the same and a method for delivering and storing the oligomer and/or polymer.

### BACKGROUND ART

A scientist consulting a scientific publication or article relating to an interesting clone of a molecular substance (e.g., genomic DNA, cDNA, RNA, mRNA and PNA) would sometimes like to use this clone for making experiments. In order to obtain the clone, he needs to contact the author of the publication and start a series of formality procedures necessary to obtain it. In some cases, the address contained in the publication has changed, or the scientist has moved to another laboratory and as a consequence it takes a long time to obtain the clone. In some cases, the vector or cell comprising the interesting sequence is no longer available and the scientist has no prompt availability of it and needs to make it again.

After the scientist makes a request for the molecular substance of interest, the molecular substance is sent to him according to the delivery systems known in the art, for example, in the form of a tube. The molecular substance of interest can also be delivered upon request in form of sheet-like supports on which RNA, PNA, other high molecular fragment or DNA is fixed or printed (U.S. Pat. No. 6,258,542). However, all these delivery systems known in the art require a request from the interested receiver, the preparation of the requested molecular substance in a form suitable for dispatching, manufacturing of the device suitable for delivery and delivery it. Further, the delivery may take several months.

The present invention solves the problem in the art by providing a printed material from which at least an oligomer and/or polymer can be obtained immediately and directly, without need to make a request for it.

The invention also provides a method for preparing such a printed material.

The invention further provides a method for delivering and/or storing an oligomer and/or a polymer.

### BRIEF DESCRIPTION OF THE DRAWINGS

FIG. 1 shows an article having spots of an oligomer and/or polymer.

FIG. 2 shows a product of an oligomer and/or polymer applied on a support together with a printed material.

FIG. 3 shows a product of an oligomer and/or polymer applied on a printed material.

FIG. 4 shows a book having a support as an attached sheet on which oligomers and/or polymers have been applied.

FIG. 5 shows a book having supports as attached cards on which oligomers and/or polymers have been applied.

FIG. 6 shows a book having a support as a page on which oligomers and/or polymers have been applied.

FIG. 7 shows a loose-leaf book composed of a cover, binding rings and loose-leaf sheets.

FIG. 8 shows an article having spots of oligomers and polymers (high and low molecular substances).

FIG. 9 shoes an article having printed letters of oligomers and polymers (high and low molecular substances).

FIG. 10 shows a card having an oligomer and/or polymer applied thereon and a barcode.

FIG. 11 is a photograph of electrophoresis which indicates experimental results of Example 1.

FIG. 12 is a gel showing the PCR recovery of cDNA spotted on the DNA sheets in presence of different amounts of Mg++as explained in Example 3. The presence of visible bands confirms the amplification and recovery of DNA.

FIG. 13 shows a gel of three cDNA clones recovered from DNA sheet kept at 140.degree. C. for 30 seconds according to the experiment of Example 4. The cDNAs have been successfully amplified and recovered.

FIG. 14 shows a gel of three cDNA clones recovered from DNA sheets kept at -40.degree. C. for 12 hours according to the experiment of Example 4. The cDNAs have been successfully amplified and recovered.

FIG. 15 shows how high-pressure have been applied of the DNA through the use of vice (manriki in Japanese). A more detailed explanation is reported in Example 5.

FIG. 16 shows a gel of three cDNA clones recovered according to the experiment of Example 5. The cDNAs have been successfully amplified and recovered from DNA sheet kept under high pressure.

FIG. 17 is an explanation of the experiment of FIG. 16.

FIG. 18A shows a gel of three DNA clones recovered according the experiment of Example 6. The cDNAs have been successfully amplified and recovered from a DNA sheet kept at 37.degree. C. with 70% humidity for 12 hours.

FIG. 18B shows a gel of three DNA clones recovered according to the experiment of Example 7. The cDNAs have been successfully amplified and recovered form a DNA sheet kept under rubbing for 12 hours.

FIG. 19 is a schematic example of amplification and ligation of the two exons of a gene (in this case hLH) from genomic DNA as reported in Example 8. The amplification and ligation is carried out by a set of primers comprising a pair of primers for each exon. Primer HsLH1Rt of exon 1 is also partially complementary to an extremity of exon2. Primer HsLH2F of exon 2 is also partially complementary to an extremity of exon 1.

FIG. 20 is an example of how the set of primers for the preparation of cDNA from genomic DNA may be spotted on a support. Explanation is given in Example 8.

FIG. 21 shows a gel of the two exons and full-length cDNA of hLH prepared from genomic DNA according to the experiment carried out on Example 8. Lane 1 shows markers and their relative number of bp. Lane 2 shows the band of recovered exon 2. Lane 3 shows the band of recovered exon 1. Lane 4 shows from the bottom to the top 4 bands: exon 1, an unidentified band, exon 2 and dull-length cDNA of hLH, respectively. Lanes 5, 6 and 7 refer to the same experiments as in lanes 2, 3 and 4 but without template (genomic DNA).

### EXPLANATION OF LETTERS OR NUMERALS

1: Printed material

2: Support

3: Spot of oligomer and/or polymer (high molecular substance)

4: Spot of oligomer and/or polymer (low molecular substance)

5: Grid line

6: Perforated line

7: Hole

8: Pocket

9: Slit

10: Binding ring

11: Cover

12: Loose-leaf sheet

20: Printed letters containing an oligomer (a low molecular substance)

21: Printed letters containing an oligomer and/or polymer

30: Barcode

### BEST MODE FOR CARRYING OUT THE INVENTION

Various embodiments of the printed material of the present invention are hereinafter explained by reference to the drawings.

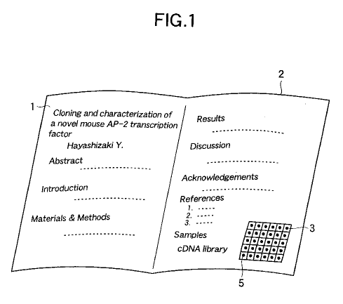

FIG. 1 shows a printed material (1) which is an article comprising spots (3) of an oligomer and/or polymer (e.g., at least one of DNA, cDNA, RNA, mRNA, PNA, primer, plasmid, vector, enzyme, buffer, and the like).

The article is in the form of a folded leaflet. The printing paper of the article is a support (2) on which the oligomer and/or polymer is applied. The printing paper has the spots of the oligomer and/or polymer in the centers of grids of a checker-board pattern. If a scientist reads this article and wants to make an experiment using the oligomer and/or polymer, he can obtain this substance immediately by cutting off a strip with the desired spots from the leaflet along grid lines (5) and eluting the oligomer and/or polymer from the strip. When the oligomer and/or polymer is a nucleic acid, it can be advantageously recovered by amplification techniques known in the art, for example PCR by using the proper primers. These primers may be included in the same support or in a separate support of the printed material. The nucleic acid recovered can also be transferred into a prokaryotic or eukaryotic host cell, for instance E. coli, according to known techniques, for example Sambrook et al., 1989. This article allows the reader to obtain the oligomer and/or polymer easily and immediately after he or she has read it. It is not necessary for the reader to contact the author or a depository institution having the oligomer and/or polymer and wait long to get it in his or her possession.

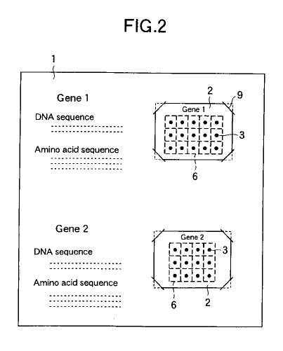

FIG. 2 shows a product of an oligomer and/or polymer applied on a support together with a printed material. The support (2) is in the form of a card and is attached to the printed material (1). The printed material is in the form of a leaflet. In FIG. 2, the card is attached to the printed material by inserting the corners of the card into slits (9) made in the printed material. The card has one or more spots (3) of the oligomer and/or polymer. Each spot can be detached easily from the card by tearing it off along perforated lines (6). Preferably, when the oligomer and/or polymer is an oligonucleotide or polynucleotide, the card may further comprise spots of PCR primers which are necessary to amplify the oligonucleotide or polynucleotide. The printed material contains printed information about the oligomer and/or polymer, such as the names of the oligomer and/or polymer, DNA sequences, amino acid sequences, or the like. This product is stable and is not bulky. Therefore, it can be stored at room temperature in a small space. Also, it can be delivered easily.

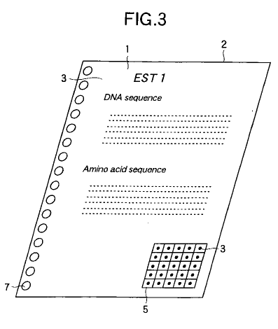

FIG. 3 shows a product of an oligomer and/or polymer applied on a printed material. The printed material (1) is in the form of loose-leaf folder having holes (7) along the left edge. The loose-leaf folder is a support (2) on which the oligomer and/or polymer is applied. The loose-leaf folder has the spots (3) of the oligomer and/or polymer in the centers of grids of a checker-board pattern. Users can obtain the oligomer and/or polymer by cutting off a strip with the desired spots from the loose-leaf folder along grid lines (5) and eluting the oligomer and/or polymer from the strip. The printed material contains printed information about the oligomer and/or polymer, such as the names of the oligomer and/or polymer, DNA sequences, amino acid sequences, etc. This product is stable and is not bulky. Therefore, it can be stored at room temperature in a small space. Also, it can be delivered easily.

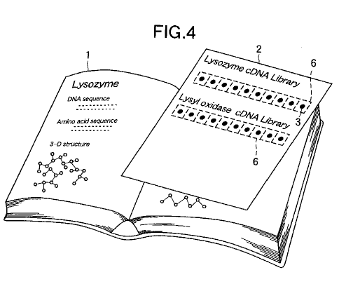

FIG. 4 shows a printed material (1) which is a book, journal, a magazine, or the like having a support (2) as an attached sheet on which oligomers and/or polymers have been applied. The attached sheet has one or more spots (3) of the oligomer and/or polymer. Each spot can be cut easily from the sheet or detached easily from the sheet by tearing it off along perforated lines (6). The sheet may also comprise PCR primers for the amplification of oligonucleotide and/or polynucletide. The book contains printed information about the oligomer and/or polymer, such as the names oligomer and/or polymer, and also the DNA sequences, amino acid sequences, three-dimensional structures of the proteins or peptides comprising the amino acid sequences, etc. From the book, scientists can obtain not only information about the oligomer and/or polymer of interest but also their materials and they can start making an experiment easily and immediately. This type of book is desirable for manufacturers because a book and an attached sheet can be produced in different factories. In order to produce the attached sheet, it is necessary to use special equipment and/or facilities for treating an oligomer and/or polymer, which are not usually available in print shops. If an attached sheet having the spots of a oligomeer and/or polymer is sold separately from the book, this is convenient for users because they can obtain the oligomer and/or polymer by simply buying another sheet after they have used all spots of the oligomer and/or polymer.

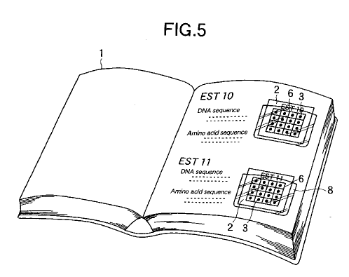

FIG. 5 shows a printed material (1) which is a book having supports (2) as attached cards on which oligomers and/or polymers have been applied. The cards are put in pockets (8) made on pages of the book. Preferably, the pockets are made of a transparent film. The cards have one or more spots (3) of the oligomers and/or polymers. Each spot can be detached easily from the card by tearing it off along perforated lines (6). The cards may also comprise PCR primers for the amplification of oligonucletides and/or polynucleotides. The book contains printed information about the oligomer and/or polymer, such as the name, DNA sequences, amino acid sequences, three-dimensional structures of the proteins or peptides comprising the amino acid sequences, etc. From the book, scientists can obtain not only information about the oligomer and/or polymer of interest but also their materials and they can start making an experiment easily and immediately. This type of book is desirable for manufacturers because a book and attached cards can be produced in different factories. In order to produce the attached cards, it is necessary to use special equipment and/or facilities for treating oligomers and/or polymers, which are not usually available in print shops. If an attached card having the spots of an oligomer and/or polymer is sold separately from the book, this is convenient for users because users can obtain the oligomer and/or polymer by simply buying another card after they have used all spots of the oligomer and/or polymer.

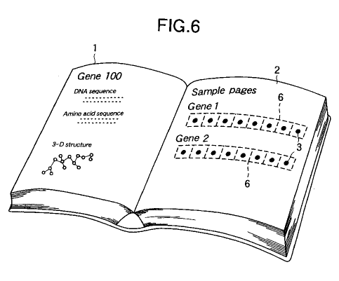

FIG. 6 shows a printed material (1) which is a book having a support (2) as a page on which an oligomer and/or polymer has been applied. This page has one or more spots (3) of the oligomer and/or polymer and the printed names of the oligomer and/or polymer. Each spot can be detached easily from the book by tearing it off along perforated lines (6). The page may also comprise PCR primers for the amplification of oligonucleotide and/or polynucleotide. The book contains printed information about the oligomer and/or polymer on the other pages. Examples of the information include the names of the oligomer and/or polymer, DNA sequences, amino acid sequences, three-dimensional structures of the proteins or peptides comprising the amino acid sequences, etc. From the book, scientists can obtain not only information about the oligomer and/or polymer of interest but also their materials and they can start making an experiment easily and immediately. This type of book is convenient for users in that information and materials are provided on different pages. When the user wants to get many kinds of oligomer and/or polymer, he can obtain these substances in a shorter time than in the case where information and materials of each oligomer and/or polymer are provided on the same page.

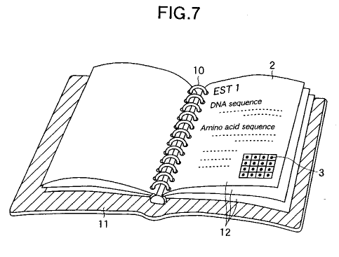

FIG. 7 shows a printed material (1) which is a loose-leaf book composed of a cover (11), binding rings (10) and loose-leaf sheets (12). The loose-leaf sheets are as explained FIG. 3. The cover (11) is however not essential. For instance a cover-free binding ring can be used. The loose-leaf sheets are bound all together by the binding rings fixed on the cover (or by the cover-free binding ring) to form the loose-leaf book. A manufacturer can provide users with a supplemental sheet when a new oligomer and/or polymer is added to the book. Also, the manufacturer can provide the user with another page that the user wants, if he has used all spots of an oligomer and/or a polymer.

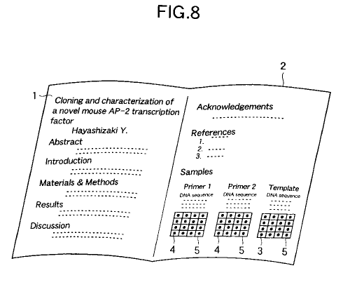

FIG. 8 shows a printed material (1) which is an article having spots (3) of an oligomer and/or polymer. This is a modification of the article of FIG. 1. The printing paper of the article is a support (2) on which the oligomer and/or polymer is applied. The printing paper has the spots of the oligomer and/or polymer in the centers of grids of a checker-board pattern. The printing paper may also comprise spots (4) of PCR primers for use in the amplification of oligonucleotide or polynucleotide and which are in the centers of grids of another checker-board pattern. If a scientist who reads this article wants to make an experiment using the oligomer and/or polymer, he can obtain these substances immediately by cutting off a strip with the desired spots of the oligomer and/or polymer from the article along grid lines (5) and eluting these substances from the strip. As a further aspect of the present invention, the printed material may comprise more than one or even all the components necessary for carrying out the experiment. For example, the printed material according to the invention may comprise at least one of DNA, primer, plasmid, vector, enzyme, buffer, other solutions, and the like, so that the scientist has the immediate availability of the substances and/or proper concentration for carrying out the experiment, by simply recovering them from the paper. The present invention, therefore, also relates to a printed material comprising part of or all the compounds and solutions necessary for carrying out an experiment.

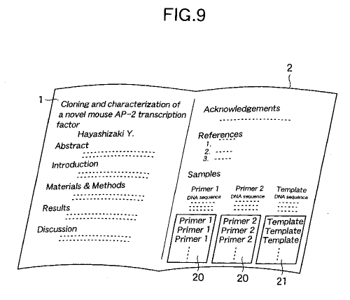

FIG. 9 shows a printed material (1) which is an article having printed letters containing an oligomer and/or polymer (21) (e.g., DNA, cDNA, RNA, mRNA, PNA, plasmid(s), enzyme(s), buffer, and the like) and printed letters further comprising specific PCR primers (20) for use in the amplification of oligonucleotide and/or polynucleotide. The article is in the form of a folded leaflet. The article can also comprising more than one folded leaflet. They can be in free form or bound together by, for example, fastener-releasable means commonly known in the art. The printing paper of the article is a support (2) on which the oligomer and/or polymer is applied. The printing paper has the printed letters containing an oligomer and/or polymer (21) and the printed letters containing the primers (20) in the spaces between lines of tables. If a scientist who reads this article wants to make an experiment using the oligomer and/or polymer, he can obtain these substances immediately by cutting off a strip having the printed letters from the leaflet and eluting these substances from the strip. This article allows the readers to obtain the oligomer and/or polymer easily and immediately after they read it. It is not necessary for him to contact the author or a depository institution having an oligomer and/or polymer and wait long to get it (them) in his possession.

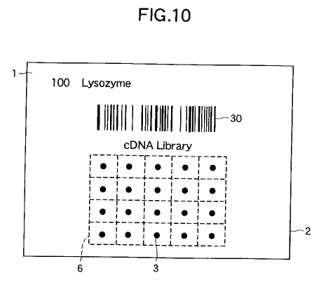

FIG. 10 shows an embodiment of a printed material (1) consisting of a support (2) having an oligomer and/or polymer applied thereon. The printed material (support) is in the form of a card. This card has a barcode (30) and one or more spots (3) of the oligomer and/or polymer. Each spot can be detached easily from the card by tearing it off along perforated lines (6). The card number (i.e., 100), the name of the protein encoded by the oligomer and/or polymer (i.e., Lysozyme) and the kind of the oligomer and/or polymer (i.e., cDNA library) are printed on the card. The card may have spots of any other oligomer such as PCR primers. From the barcode, information about the oligomer and/or polymer can be obtained by using a barcode reader. Examples of the information include DNA sequences, amino acid sequences, three-dimensional structures of the proteins or peptides comprising the amino acid sequences, etc. The card may be put together with other cards and packed in a box together with a list of these cards. This type of card is convenient in that an oligomer and/or polymer can be stored at room temperature in a smaller space. Also, it is useful in delivering an oligomer and/or polymer easily

In a modification of the printed material shown in FIG. 10, various kinds oligomer and/or polymer may be applied as spots on a support (card) (2) and a barcode (30) may contain information about the position of each of the oligomer and/or polymer on the card as well as other information such as the name of each of the oligomer and/or polymer, DNA sequence, amino acid sequence, three-dimensional structure of the protein or peptide comprising the amino acid sequence, etc. The operator can read the barcode by a barcode reader to obtain information about the oligomer and/or polymer applied on the card. From the information, he can select an oligomer and/or polymer of interest and provide a suitable device with instructions to elute and recover the oligomer and/or polymer of interest from the card.

The use of the bar code is not limited to this embodiment but can used in any support according to the present invention.

When an oligomer and/or polymer is fixed as spots on a support, a strip having one or more spots can be cut off with scissors, a cutter and the like, the strip can be transferred to a micro-test tube, and the oligomer and/or polymer may be eluted from the strip and amplified under ordinary conditions by polymerase chain reaction.

In this case, one or more primers for polymerase chain reaction may be supplied in the form of dots, or powder or liquid

The primer(s) in the form of spots may be placed anywhere on any page, or may be added at the end of the printed material as an appendix.

Even if there are various types of oligomer and/or polymer, it is also possible to supply a primer in the form of liquid or dry powder by containing such primer in an ampoule or a small test tube in such a case where a common primer may be used in a certain extent so that the number of types of primer may be reduced. The nucleic acid can also recovered by transferring it into a plasmid, a vector and/or an eukaryotic or prokaryotic host cell, for example E. coli or the like, according to known technique (for ex. Sambrook et al., 1989). The nucleic acid can be maintained and stored in this form until next use.

The present invention discloses a method for preparing a printed material comprising at least one support having at least one oligomer and/or polymer applied thereon, comprising the step of applying the oligomer and/or polymer on the support before or after printing the material. The oligomer and/or polymer can be fixed or printed on the support according to known techniques.

The present invention also provides a method for delivering and/or storing at least one oligomer and/polymer applied on at least one support comprised in the printed material, comprising the step of i) applying the oligomer and/or polymer on the support before or after printing the material, and ii) delivering and/or storing the printed material comprising the oligomer and/or polymer.

When the oligomer and/or polymer is nucleic acid, the present invention discloses a method for storing a nucleic acid by providing a printed material and/or a support comprising nucleic acid applied thereon, recovering the nucleic acid by transferring it into a host cell, and storing it.

The present invention therefore discloses a method for delivering biological molecules comprising the steps of applying at least one nucleic acid on the support before or after printing of the material, delivering the printed material, recovering the at least one nucleic acid by elution, amplification and/or transferring it from the support into a host molecule. In case the biological material applied on the support is a plasmid comprising cDNA, the plasmid is recovered from the support. Then the plasmid is subjected to amplification according to known technique, for instance PCR, and the cDNA is amplified. Then an electrophoresis gel is carried out (ex. Sambrook et al., 1989) and the cDNA can be recovered from the gel and used for any purpose. As said above, the amplified cDNA can also be "stored" into a host cell and kept in that form until next use. The DNA included in the host cell can also further delivered in this form.

The invention also provides a printed material comprising part of or all the substances necessary for an experiment, for example nucleic acid, primers, enzymes and/or solutions like buffers. All these molecules or substances can be applied on the support and then recovered by the reader or receiver, so that he can immediately carrying out the experiment and does not need to request the single substances, measure the concentrations of the substances and prepare them.

The invention therefore also relates to a method for providing, delivering and/or storing the oligomer and/or polymers necessary for carrying out an experiment on a printed material.

This embodiment is however not limited to printed material. Part or all the substances necessary for carrying out an experiment, for example nucleic acid, primers, enzyme and buffers can be applied on a single support, like a card or a sheet. Accordingly, the present invention also relates to a single support comprising more than one or all the substances for carrying out an experiment. Further, the invention provides a kit for carrying out an experiment comprising more than one or all the substances for carrying out an experiment applied on a support. The more than one substance can be nucleic acid, primer(s), enzyme(s), buffer, other solutions and the like. Preferably, all the substances necessary for carrying out the experiment can be added on the support. The support can be paper, card, sheet, and the like, as described in any embodiment of the present invention. Preferably, the kit comprises more than one substance and solution for carrying out an experiment applied on a water-dissolvable paper (for instance Mishima paper) according to the invention.

The support according to the invention can also be a wafer, as described above. The invention therefore related to a printed material comprising oligomer and/or polymer applied on a wafer and to a method for delivering and/or storing oligomer and/polymer by providing a printed material comprising a wafer having oligomer and/or polymer applied thereon.

Further, the present invention also provides a wafer comprising a oligomer and/or polymer and to a method for delivering and/or storing oligomer and/or polymer by applying oligomer and/or polymer on a wafer and delivering and/or storing it. The oligomer and/or polymer can be recovered by dissolving the wafer into water. Furthermore, the present invention also provides a method for synthesizing cDNA, exons and preferably full-length cDNA, from genomic DNA. The method is carried out from the genomic DNA comprising one specific gene, for example human luteinizing hormone (hLH) (however the method is not limited to the preparation of the full-length FL or exon(s) of this gene but any gene or exon can be prepared).

The starting material is the whole genomic DNA of a cell, for instance a human cell. Genomic DNA can be purchased (for instance from BD Bioscience Clontech, US) or prepared with standard technology. A source of genomic DNA can be any biological material obtained from a patient, for example blood. For the purpose of the present invention the genomic DNA in any form, including genomic DNA prepared from blood, fluid, liquid, or any other biological material or even purchased or prepared in purified form will be here also indicated as "template" or "template DNA".

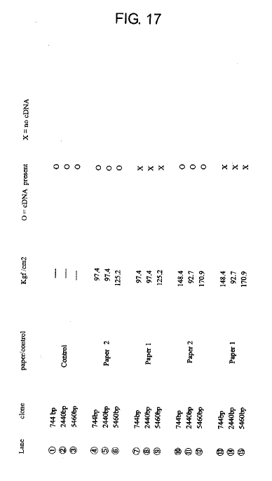

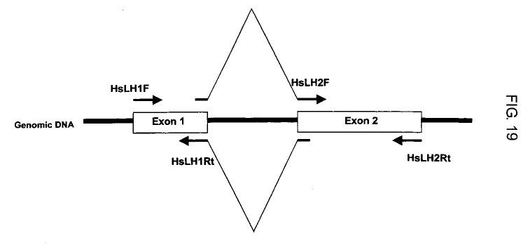

An example of the realization of this method for the preparation of FL-hLH (full-length human luteinizing hormone), which is constituted by two exons, is shown in FIG. 19 and Example 8. A set of primers capable to amplify and/or ligating the exons of the desired gene are used. The set of primers is composed of a pair of primers capable of hybridizing with each exon. One primer of a first pair of primers hybridizes with the first exon and at the same time also partially hybridize with the extremity of the other (next) exon. For instance, in FIG. 17, primer HsLH1Rt, which hybridized with exon 1, is also partially complementary to an extremity of exon2. Primer HsLH2F, which hybridizes with exon 2, is also partially complementary to an extremity of exon 1. The final amplification products comprise a cDNA which comprises all exons of the desired gene and is therefore a FL-cDNA (full-length cDNA).

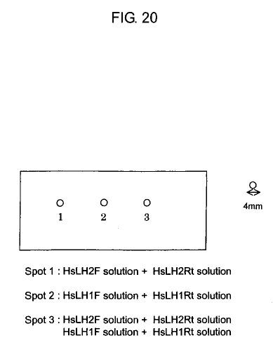

As it is shown in FIG. 19 and Example 8 a plurality of set of primers can be used of the preparatio of cDNAs from template DNA. In the example, the pair of primers for amplification of exon 1, the pair of primers for amplification and exon 2 and the set of primers (therefore comprising all the set of primers) for the amplification and ligation of the exons can be spotted in the same support. In this case, not only the full-length of the gene but also one or more exons will be synthesized (as shown in FIG. 20). Accordingly, the present invention also provides a printed material and/or support comprising at least one set of primers applied thereon, this at least set of primers capable of synthesizing a FL-cDNA from the genomic DNA. This set of primers comprises primers for the amplification of the exons of a gene comprised in the template DNA and primers for the ligation of the amplified exons into a FL-cDNA. The printed material and/or support may also comprise one or more primers for amplifying one or more exons. Preferably, the printed material and/or support may comprise a set of primers for the synthesis of FL-cDNA and optionally further set(s) of primers for the amplification of one or more exons.

The printed material and/or support may further comprise one or more enzyme catalyzing these reactions (for instance Taq polymerase) and/or any solution necessary for carrying out the experiment, for instance a buffer solution.

The reader or receiver of the printed material and/or support can therefore recover the at least set of primer(s) from the printed material and/or support and add the template DNA, enzyme and buffer. In case the enzyme and buffer are also applied on the printed material and/or support, the receiver can recover all the elements from it, without need to obtain the enzyme and buffer from a different source. The reader or receiver can then carry out the experiment, and recover the FL-cDNA obtained. The product of the experiment reaction can be applied on an electrophoresis gel, according to known technique (example, Sambrook et al., 1989) and the FL-cDNA DNA band and the bands of the exons can be identified on the gel.

Accordingly, the present invention therefore provides a method for delivering and/or storing a printed material and/or support comprising the step of applying at least one set of primers on a printed material and/or support, the at least set of primers being capable of synthesizing FL-cDNA from the genomic DNA, and delivering and/or storing the printed material and/or support.

A doctor, who wishes to analyse one or more particular genes of a patient may obtains a blood or other biological material sample (template) from a patient. Then, he can use the kit according to the invention comprising a support comprising at least one or more sets of primers applied thereon, each set of primers specific for amplification and ligation of a specific FL-cDNA gene. Preferably, the support further comprises the enzyme, for instance Taq Polymerase, and buffer solution. The doctor or an assistant may recover the set of primers and optionally enzyme and buffer from the support and mix them with the template DNA. Carrying out the amplification (ex. PCR) process and electrophoresis. The electrophoresis shows the FL-cDNA gene. The doctor may immediately make a diagnosis in case of deletion/insertion of the particular gene.

The FL-cDNA obtained can also used for SNP analysis (for example sequencing) or for protein expression assay.

The present invention therefore provides for a Kit and/or a diagnostic kit comprising a support comprising at least one set of primers for the synthesis of cDNA and/or FL-cDNA from a template DNA. The present invention also provides for a diagnotic method comprising the steps of 1) preparing a template DNA (blood, fluid or other biological material) from a patient, 2) recovering at least the set of primers from the support, and optionally also recovering enzyme and buffer from the support, 3) mixing the template, set of primers, enzyme and buffer, 4) carrying out amplification and/or ligation process, 5) electrophoresis and 6) determining the diagnosis on the basis of the cDNA (exon) and/or FL-cDNA obtained.

The present invention also provides a method for preparing cDNA and/or FL-cDNA from a template comprising the steps of: 1) recovering at least one set of primers and optionally enzyme and buffer from a support, 2) mixing the set of primers, enzyme and buffer with the template, 3) carrying out the amplification and/or ligation of the exons, 4) electrophoresis, 5) optionally recovering of the cDNA and/or FL-cDNA from the electrophoresis means.

Further, the above method comprises the step of analysing the obtained cDNA and/or FL-cDNA for SNP, deletion or insertion analysis or the step of expressing a peptide, polynucleotide or protein. SNP and aberration analysis can be carried out by sequencing the cDNA and/or FL-cDNA or other known technique.

The peptide, polynucleotide or protein expression can be carried out by any peptide, polynucleotide or protein expression assay, for example the assay known as "Protein truncation test" or "Linked SP6/T7 in vitro transcription/translation kit" (2002 catalog number 188839 and 1814346, respectively), of Roche Diagnostic.

A method of preparation of full-length cDNA of hLH from genomic DNA according to the invention will be illustrated in more detail in example 8.

The support can also be in form of powder or solution preparation. Accordingly, the invention also provides a powder preparation comprising oligomer and/or polymer mixed with a carrier, for example methylcellulose. The carrier can be any inert carrier suitable to be mixed with the oligomer and/or polymer, for example any carrier usually utilized for the preparation of drugs. The powder preparation may further comprise enzyme and buffer solution.

The oligomer and/or polymer mixed with the carrier may be nucleic acid. Further, at least one primer or set of primers can also be mixed to the preparation. Optionally, enzyme and/or buffer can also mixed to the preparation.

The invention therefore provides a method for delivering and/storing a powder preparation as above comprising mixing a carrier to an oligomer and/or polymer, and delivering and/or storing such preparation. For example, the method comprises the steps of making a preparation comprising mixing nucleic acid and at least one primer or set of primers and optionally enzyme and buffer solution with an inert carrier, and delivering and/or storing such preparation. According to a particular realization, the nucleic acid is genomic DNA, and the at least one set of primers is capable of synthesizing full-length DNA from genomic DNA as above described. The invention therefore also relates to a method for preparing full-length DNA by comprising by using the preparation as above.

The preparation can also be in solution form. Accordingly, the oligomer and/or polymer may be mixed in a liquid carrier and included in water-soluble shell. Such water-soluble shell can be for example made is the same way of shell comprising drug according to known technique. The liquid preparation may contain nucleic acid and at least one primer or set of primers, and optionally buffer solution. Alternatively, the liquid preparation may comprise primer, enzyme and buffer but no nucleic acid. The liquid preparation can be dissolved into water solution with addition with the substance (for instance enzyme) necessary for starting the reaction.

EXAMPLES

The present invention will be explained in more detail with reference to the following examples. It should be noted, however, that the scope of the present invention is not limited by these examples.

Example 1

First, various types of sheets each having 5 mm.times.5 mm size (A) as well as having 10 mm.times.10 mm size (B) were prepared.

Two solutions were prepared as DNA samples. One solution (H solution) contained a plasmid DNA fragment of about 1.5 kbp including 1377 bp of .lambda.DNA fragment inserted in pBS at a site of EcORV at concentration of 333 ng/.mu.l. The other solution (F solution) contained the same plasmid DNA and fountain pen ink at concentrations of 333 ng/.mu.l and 17% (v/v) respectively.

Then, 3 .mu.l (1 .mu.g) each of the H solution and the F solution was spotted on a sheet having the size (A), while 6 .mu.l (2 .mu.g) each of the solutions was spotted on a sheet having the size (B), and these sheets were dried at 65.degree. C. for 30 minutes, respectively. Thereafter, the sheet having the size (A) was immersed into 200 .mu.l of water, while the sheet having the size (B) was immersed into 300 .mu.l of water, respectively. These immersed sheets were dried at 65.degree. C. for 10 minutes, and further they were treated at room temperature for 2 hours to thereby conduct elution.

Phenol extraction (extracting twice with phenol:chloroform:isoamyl alcohol=25:24:1) was repeated upon the eluate, and then DNA was recovered by an ethanol precipitation method.

The resulting DNA was dissolved in 10 .mu.l of water, and PCR was conducted as follows. After the first reaction at 94.degree. C. for 3 minutes, forty cycles of the reaction were repeated at 94.degree. C. for 1 minute and 68.degree. C. for 2 minutes with a final reaction volume: 25 .mu.l, a reaction composition: M13 (SEQ ID NO:1) primer (M3-30: 0.5 .mu.l of 10 .mu.M 5'-CAGTCACGACGTTGTAAAACGACGGCCAGT-3', 0.5 .mu.l of 10 .mu.M RV32 (SEQ ID NO:2): 5'-GATAACAATTTCACACAGGAAACAGCTATGAC-3'), 2.5 .mu.l of ExTaq 10.times. buffer solution, 2 .mu.l of 2.5 mM dNTP, 1 unit of ExTaq, and DNA. This DNA was a DNA template of about 1.5 kbp in size containing .lambda.DNA of 1377 bp in size together with plasmid DNA molecules located at both ends.

The base sequence of DNA (SEQ ID NO:3) was as follows: 1 GATAACAATTTCACACAGGAAACAGCTATGACCATGATTACGAATTCGAT ATCGCATTTTTCACCATGCTCATCAAAGACAGTAAGATAAAACATTGTAA CAAAGGAATAGTCATTCCAACCATCTGCTCGTAGGAATGCCTTATTTTTT TCTACTGCAGGAATATACCCGCCTCTTTCAATAACACTAAACTCCAACAT ATAGTAACCCTTAATTTTATTAAAATAACCGCAATTTATTTGGCGGCAAC ACAGGATCTCTCTTTTAAGTTACTCTCTATTACATACGTTTTCCATCTAA AAATTAGTAGTATTGAACTTAACGGGGCATCGTATTGTAGTTTTCCATAT TTAGCTTTCTGCTTCCTTTTGGATAACCCACTGTTATTCATGTTGCATGG TGCACTGTTTATACCAACGATATAGTCTATTAATGCATATATAGTATCGC CGAACGATTAGCTCTTCAGGCTTCTGAAGAAGCGTTTCAAGTACTAATAA GCCGATAGATAGCCACGGACTTCGTAGCCATTTTTCATAAGTGTTAACTT CCGCTCCTCGCTCATAACAGACATTCACTACAGTTATGGCGGAAAGGTAT GCATGCTGGGTGTGGGGAAGTCGTGAAAGAAAAGAAGTCAGCTGCGTCGT TTGACATCACTGCTATCTTCTTACTGGTTATGCAGGTCGTAGTGGGTGGC ACACAAAGCTTTGCACTGGATTGCGAGGCTTTGTGCTTCTCTGGAGTGCG ACAGGTTTGATGACAAAAAATTAGCGCAAGAAGACAAAAATCACCTTGCG CTAATGCTCTGTTACAGGTCACTAATACCATCTAAGTAGTTGATTCATAG TGACTGCATATGTTGTGTTTTACAGTATTATGTAGTCTGTTTTTTATGCA AAATCTAATTTAATATATTGATATTTATATCATTTTACGTTTCTCGTTCA GCTTTTTTATACTAAGTTGGCATTATAAAAAAGCATTGCTTATCAATTTG TTGCAACGAACAGGTCACTATCAGTCAAAATAAAATCATTATTTGATTTC AATTTTGTCCCACTCCCTGCCTCTGTCATCACGATACTGTGATGCCATGG TGTCCGACTTATGCCCGAGAAGATGTTGAGCAAACTTATCGCTTATCTGC TTCTCATAGAGTCTTGCAGACAAACTGCGCAACTCGTGAAAGGTAGGCGG ATCCCCTTCGAAGGAAAGACCTGATGCTTTTCGTGCGCGCATAAAATACC TTGATACTGTGCCGGATGAAAGCGGTTCGCGACGAGTAGATGCAATTATG GTTTCTCCGCCAAGAATCTCTTTGCATTTATCAAGTGTTTCCTTCATTGA TATTCCGAGAGCATCAATATGCAATGCTGTTGGGATGGCAATTTTTACGC CTGTTTTGCTTTGCTCGACATAAAGATATCAAGCTTGGCACTGGCCGTCG TTTTACAACGTCGTGACTG

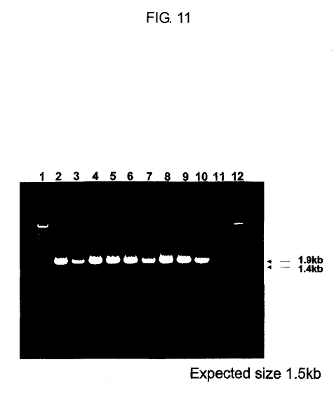

After the reaction, 5 .mu.l of the reaction product was subjected to 1% agarose electrophoresis to detect (about 1.5 kbp of) a PCR product. The results are shown in FIG. 11.

Lane 1 is a DNA size marker (.lambda./StyI 200 .mu.g), lane 2 shows the fragment obtained by spotting the F solution onto a medical paper having the size (A), lane 3 shows the fragment obtained by spotting the F solution onto a medical paper having the size (B), lane 4 indicates the fragment obtained by spotting the F solution onto a copy paper having the size (A), lane 5 shows the fragment obtained by spotting the F solution onto a copy paper having the size (B), lane 6 shows the fragment obtained by spotting the H solution onto a medical paper having the size (A), lane 7 shows the fragment obtained by spotting the H solution onto a medical paper having the size (A), lane 8 shows the fragment obtained by spotting the H solution onto a copy paper having the size (A), lane 9 shows the fragment obtained by spotting the H solution onto a copy paper having the size (B), lane 10 is a fragment with no sheet (positive control), lane 11 is another fragment with no sheet (negative control), and lane 12 is a DNA size marker (.lambda./StyI 200 .mu.g).

Three .mu.l of DNA was applied to the lane 2, lane 3, and lane 6, respectively, while 1/50 .mu.l of the DNA was applied to the lane 4, lane 5, lane 7, lane 8, and lane 9, respectively.

More specifically, it is clear from the above described experimental results that the DNA fixed to the support in the DNA-fixed support prepared by the use of ordinary PPC or the like manufactured from cellulose as the support can be preserved at ordinary temperatures, and besides, the DNA fixed to the support can be recovered by elution from the support in the DNA-fixed support, and in addition, the DNA thus recovered by elution can be amplified by polymerase chain reaction.

In order to have the DNA adhere to the support, the following procedure may be adopted: DNA is picked up by use of a pin, the DNA on the pin is further transferred to the support, a DNA solution contained in a syringe is dropped onto the support so that the DNA adheres to it, and the DNA solution is allowed to adhere to the support in a printed state by utilizing an existing printing technique.

In this case, a printing technique such as an ink-jet printing system which is applied to ink-jet printers and the like may be utilized as the existing printing system.

In order to apply a printing technique such as an ink-jet printing system, the DNA solution is used in place of a coloring matter such as printing ink, and the support corresponding to printing paper may be printed by the use of the DNA solution in accordance with the ink-jet printing system.

Thus, the existing printing technique can be very easily applied to a method for supporting DNA-fixation according to the present invention because a DNA solution can be used in place of printing ink without any modification and it can be applied by an ink-jet printing system using a piezo-electric element or a heat-producing element.

In an ink-jet printing technique, dots around 20 .mu.m to 100 .mu.m in diameter can be usually printed, so it becomes possible to allow the DNA solution to adhere to a support at high density.

Moreover, DNA in a dried state is stable unlike other biomolecules such as protein, and it can withstand sufficiently a temperature of around 100.degree. C., so that an electronic printing or thermal transfer type printing technique including one is that actuated by a laser printer can also be applied to the method for supporting DNA-fixation according to the present invention.

Example 2

An article relating to the DNA molecule used in Example 1 was prepared which contained the title, the names of authors, abstract, introduction, materials and methods, results, discussion, acknowledgements and references. At the bottom of the article, letters "TEMPLATE" were printed using the F solution of Example 1 by an ink-jet printer (EPSON, PM-760C). As a result, clear printed letters were formed on the article.

Printing materials and supports according to the invention can be printed according to the techniques known in the art.

In case of scientific subjects, books, journals, magazines, papers, articles, supports and the like may be printed, for example, with letters and figures describing the research subject. Oligomers and/or polymers, for instance DNA solutions, are then applied, for instance spotted or printed, at defined or marked positions on the same sheet of paper or in a distinct sheet of paper or support of different size and shape. Optionally, an inert dye (for instance a red dye) can be added to the oligomer and/or polymer solution applied on the support so that the position of the spot can be visible on the support.

The sheets comprising the oligomers and/or polymers applied on them are bound in form of book, journal, or the like and delivered to readers through bookstores and by courier. Researchers, students and readers who have any interest in the enclosed genes can recover and use them immediately in their research.

In order to provide a successful printed material comprising at least one support having at least one oligomer and/or polymer applied thereon several issues must be considered. At first, the oligomer and/or polymer be easily extractable by readers or receivers, with an acceptably high success rate. Secondly, oligomer and/or polymer applied on the printed material or on the support should be preserved in a stable form during book binding and shipping. Thirdly, risk of contamination should be avoided.

The preparation of an efficient printed material and support according to the invention as well as the efficient preservation and recovery of oligomer and/or polymer has been investigated in the examples 3-7. In the following experiments we used use water-dissolvable paper to form the DNA sheet. We selected 60MDP paper (Mishima Paper Co., Ltd., Japan), which rapidly dissolves in water at room temperature.

Example 3

DNA Solution Preparation

We tested three RIKEN plasmid cDNA clones with various cDNA insert sizes (744 bp, 2440 bp and 5460 bp)(indicated as SEQ ID NOS: 4-6, respectively). The cDNAs were inserted into pBluescript according to known technique (Sambrook et al., 1989).

Plasmid DNA comprising the cDNA clones as above were purified using a Qiagen Spin Miniprep Kit (Qiagen, Japan) (alternatively, ultra-centrifugation methods, for example as described in Sambrook et al., 1989 can also be used). The plasmid DNA was dissolved in TE (10 mM Tris-HCl (pH 8.0), 1 mM EDTA. DNA concentration was adjusted to 0.1 .mu.g/.mu.l. At this step an inert dye, for example a red dye, can be added to the solution in order to facilitate identification of spot position on the support at the time of recovery. However, in the present experiment the plasmid DNA solution was spot on a marked place, so that the dye was not necessary.

Preparation of DNA Sheets

About 0.1 .mu.l of the plasmid DNA solution prepared as above was transferred onto 60MDP paper used as DNA sheet (Mishima Paper Co., Ltd, Japan) (the paper can be already printed or not) using a 96-pin tool (Multi 96-multiblot replicator VP409, Bio Medical Science Inc., US), which allowed us to spot defined amounts of DNA solution onto defined positions on the paper. Spotted positions were easily identified by being spotted in a marked position on the paper. (Alternatively, by the presence of red dye mixed into the DNA solution as discussed in the "DNA solution preparation" as above). We spotted the plasmid DNA solution five times for each spot, for a total of about 0.5 .mu.L of 0.05 .mu.g of plasmids.

Extraction and Recovery of DNA

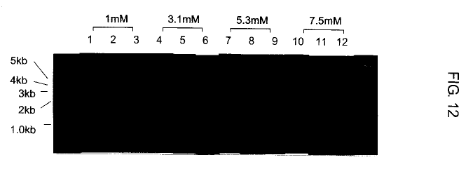

After drying the paper in air for more than 30 minutes, we extracted DNA from the sheet as follows. The piece of 60MDP paper (0.4 mm.times.0.4 mm) containing the selected DNA spot was cut out from the sheet and placed into a PCR tube followed by addition of 50 .mu.L of PCR solution. PCR solution contained 1.5 U of KOD Plus DNA Polymerase (TOYOBO, Japan), 0.2 .mu.M of the following PCR primers: -21M13 (SEQ ID NO:7) 5'-TGTAAAACGACGGCCAGT-3' and 1233-Rv (SEQ ID NO:8): 5'-AGCGGATAACAATTTCACACAGGA-3'), 0.2 mM each of dATP, dGTP, dCTP and dTTP and in presence of various concentrations of MgCl.sub.2 (1 mM, 3.1 mM, 3.5 mM and 7.5 mM, respectively, as indicated in FIG. 12). After centrifuging the resulting solution, the PCR cycle was initiated. PCR cycles comprised 2 min at 94.degree. C.; 29 cycles of denaturing (94.degree. C., 1 min), annealing (55.degree. C., 1 min) and extension (75 sec at 68.degree. C.), and 15 min at 74.degree. C. Aliquots of PCR solutions were analyzed using 1% agarose gel electrophoresis carried out according to known technique (Sambrook et al., 1989).

As an alternative, an aliquot of the solution containing the dissolved DNA sheet, can undergo PCR in a separate tube, then Escherichia coli transformation, according to known technique (Sambrook et al., 1989). Readers or receiver can keep any remaining solution as backup or for other experiments.

Result: PCR Recovery of DNAs Spotted on the DNA Sheet

FIG. 12 shows that cDNA inserts (744 bp in lanes 1, 4, 7 and 10; 2,440 bp in lanes 2, 5, 8 and 11; 5,460 bp in lanes 3, 6, 9 and 12) were amplified successfully, preferably at Mg.sup.2+ concentration of 5.3 mM. This test confirmed that the chosen conditions allow for an efficient spotting and extraction of DNA. In the two lanes at the extremities markers indicating the molecular weight (1, 2, 3, 4 and 5 kb) were added.

Purpose of Examples 4-7

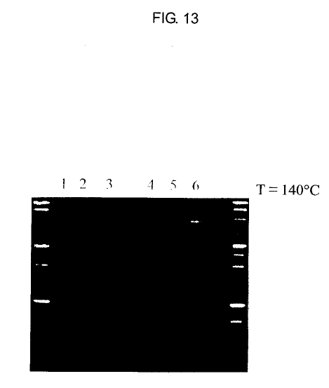

DNA sheets and DNA books must be able to endure the various conditions of which they are subject throughout the book binding process by the manufacturer or by the publisher, shipment to readers or receivers and preservation of them in ordinary rooms. Temperature, pressure, humidity, light and physical rubbing represent the major problems with the potential to qualitatively affect the DNA sheets and books. These conditions have been tested and results are reported in the followings examples 4-7. The preparation of DNA and DNA sheets was carried out in the same way and using the same clones as example 3. In the experiments of example 4-7 and as shown in FIGS. 13, 14, 16 and 18 the following markers have been used: 0.253 bp, 0.75 bp, 1 kbp, 1.5 kbp, 2 kbp, 2.5 kbp, 3 kbp, 4 kbp, 5 kbp, 6 kbp, 8 kbp and 10 kbp.

Example 4

Preservation of DNA Sheets Under Temperature Conditions

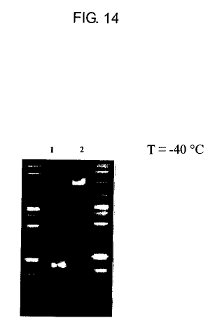

DNA sheets were treated at 140.degree. C. for 30 seconds and at -40.degree. C. for 12 hours, respectively. All the cDNA inserts were successfully amplified with PCR and recovered. In FIG. 13, the three clones as in example 3 recovered from a sheet subject to 140.degree. C. are visible in lanes 1, 2 and 3 (744, 2440 and 5460 bp, respectively). In lanes 4, 5 and 6 there are the controls (clones not treated at high temperature). FIG. 14 shows cDNA of 744 and 5460 bp in lanes 1 and 2, respectively recovered from DNA sheets treated at -40.degree. C. for 12 hours.

FIG. 13 and FIG. 14 show that no problems were identified with the effects of severe temperature and all the cDNAs were successfully amplified and recovered.

This result confirms that the DNA applied on sheets and books is tolerant to high temperature that may be experienced during book binding process, and the low temperatures that may be experienced during air transport.

Example 5

Preservation of DNA sheets Under Pressure Conditions

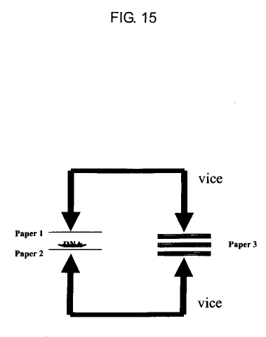

DNA sheets were kept under high pressure conditions from about 90-170 Kgf/cm.sup.2 (pressure unit conversion is 10.2 kgf/cm.sup.2=1 Mpa). FIG. 15 shows a simplified example of how the experiment has been carried out. High pressure was created by using a device known as "vice" (also called "capstan" in English; in Japan it is called "manriki") having two portions (as indicated in figure). The device can be worked so that the two portions of the vice become close one to the other creating a pressure on paper 1 and paper 2, and paper 3. Paper 2 represent the paper having the DNA applied on it; as paper 2 a mishima paper has been used. Paper 1 is a paper without DNA clone; as paper 1 a paper usually utilized for scientific journal has been used. Paper 3 is a special pressure-measure paper, which change colour according to the specific pressure applied on it. The special pressure-measure paper used in this experiment is the paper catalogue number LW purchased from Fujifilm, Japan.

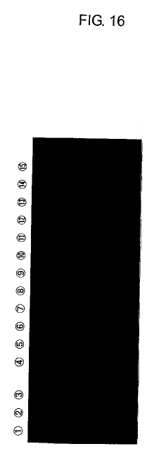

A first purpose of the experiment was to check that DNA has not been transferred from paper 2 to paper 1 during the high pressure; this represent a contamination risk test. A further purpose of the experiment was to check that the cDNA clones applied on paper 2 was not damaged by the high pressure and can be successfully recovered and amplified. FIG. 16 shows an electrophoresis with the result of the tests and FIG. 17 is an explanation of how the experiment has been carried out.

Lanes 1, 2 and 3 are the control. They represent the clones 744 bp, 2440 bp and 5460 bp, respectively recovered from a DNA paper not subject to high pressure.

Lanes 4, 5 and 6 show the three cDNAs recovered from paper 2 subject to different values of high pressure. The pressure applied was 97.4 Kgf/cm.sup.2 for the clones of lanes 4 and 5 and 125.2 Kgf/cm.sup.2 for lane 5. This shows that the cDNAS of lanes 4, 5 and 6 were successfully amplified and recovered. Lanes 7, 8 and 9 refer to papers 1 subject to pressure in the same experiment of lanes 4, 5 and 6. No contamination can be observed in lanes 7, 8 and 9. This confirms that the cDNAs applied on papers 2 did not pass to paper 1 at these values of pressure.

Lanes 10, 11 and 12 relates to the three cDNAs recovered from paper2 underpressureof 148.4, 92.7 and 170.9 Kgf/cm.sup.2. All the cDNAs have been recovered under these pressure values. Lane 13, 14 and 15 refer to the papers 1 subject to the same experiments as lanes 10, 11 and 13. NO contamination was observed in lanes 13, 14 and 15.

This result confirms that the DNA applied on sheets and books is tolerant to high pressure that may be experienced during book binding process and no contamination of cDNA occurred under these conditions.

Example 6

Preservation of DNA Sheets Under Humidity Conditions

The preparation of DNA and DNA sheets was carried out in the same way and with the same clones as example 3.

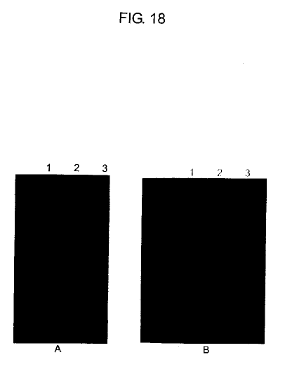

DNA sheets were spotted with the three cDNA plasmids and kept in a humidified incubator at 37.degree. C. with 70% humidity for 12 hours. DNA inserts were then recovered and amplified by PCR as described above. We observed successful recovery of DNA from these DNA sheets. FIG. 18A shows that all the three cDNA were successfully amplified.

Example 7

Preservation of DNA Sheets Under Rubbing Conditions

Furthermore, we tested whether rubbing of DNA sheets could cause any problems, such as preventing PCR amplification or introducing neighboring DNA. DNA sheets spotted with the same three cDNA plasmids were inserted into the book, and strongly shaken using a rotating shaker (180 rpm) at 37.degree. C. for 12 hours. DNA inserts were then recovered and amplified by PCR as described above.

As shown in FIG. 18B, all DNA inserts (744 bp, 2440 bp and 5460 bp) were successfully amplified. No contamination of DNA spots with neighboring spots was observed. The first lane at the left side of the gel of FIG. 16B shows the markers.

Example 8

Method for Preparing Full-Length cDNA from Genomic DNA

Human genomic DNA used as template DNA in this example was purchased from BD Biosciences Clontech, US.

Primers for synthesizing full length cDNA of human luteinizing hormone (hLH) were purchased from Invitrogen, US.

The full-length gene of human luteinizing hormone, which is the result of the present experiment, has is 503 bp and the following sequence (also reported as SEQ ID NO:9) (herebelow the sequence corresponding to exon 1 is written in capital letters and that of exon 2 in small letters): 1

The sequence of exon 1 is reported in SEQ ID NO:10. The sequence of exon 2 is reported in SEQ ID NO:11.

The sequences of the primers (the underline indicates overlapping region) were the following:

2 HsLH1F: CCAGGGGCTGCTGCTGTTG (SEG ID NO:12) HsLH1Rt: cagcacgcgcatCATGGTGGGGCAGTAGCC (SEG ID NO:13) HsLH2Ft: TGCCCCACCATGatgcgcgtgctgcaggcg (SEG ID NO:14) HsLH2R: tgcggattgagaagcctttattg (SEG ID NO:15)

HsLH1F and HsLH1Rt have complementary sequences to each end of exon 1 of human luteinizing hormone, and HsLH2F and HsLH2Rt have complementary seqnences to each end of exon 2 of the same gene. HsLH1Rt and HsLH2F have additional sequence complimentary to the next exon in order to ligate them to each other (FIG. 19)

The above primers were dissolved in 10 il of TE (10 mM Tris-HCl (pH8.0), 1 mM EDTA) with the final concentration of 10 pmol/il.

The primer solutions prepared as above was mixed for spot 1, 2, and 3.

Spot 1 solution: mixture of HsLH2F solution and HsLH2Rt solution with the ratio of 1:1;

Spot 2 solution: mixture of HsLH1F solution and HsLH1Rt solution with the ratio of 1:1;

Spot 3 solution: mixture of HsLH2F solution, HsLH2Rt solution, HsLH1F solution, and HsLH1Rt solution with the ratio of 1:1:1:1.

0.4 .mu.l of spot 1 solution, 0.4 .mu.l of spot 2 solution, and

0.8 .mu.l of spot 3 solution were transferred to each corresponding spot area on a 60MDP paper (Mishima Paper Co., Ltd, Japan) as shown in FIG. 20.

After drying the paper in air for more than 30 minutes, the primers were extracted from the sheet as follows. The pieces of 60MDP paper (0.4 mm.times.0.4 mm) containing the selected primer spot were cut out from the sheet and placed into three PCR tubes followed by addition of 50 .mu.l of PCR solution. PCR solution contained 10 mM Tris-HCl, pH8.3, 50 mM KCl, 2.5 mM MgCl.sub.2, 0.2 mM dNTP, 100 ng of template DNA (human genomic DNA, purchased from BD Biosciences Clontech, US), and 2.5 U of Taq DNA polymerase (Roche Diagnostics). PCR cycles comprised 3 min at 94.degree. C. (50 cycles: 94.degree. C. for 30 sec, 40.degree. C. for 30 sec, 72.degree. C. for 30 sec), and 72.degree. C. for 1 min.

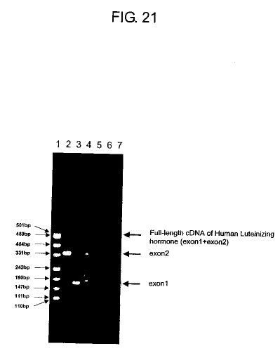

5 il of each PCR final solution (PCR solution and primers) were analyzed using 3% NuSieve 3:1 agarose (TAKARA BIO INC., Japan) gel electrophoresis carried out according to known technique (Sambrook et al., 1989). FIG. 21 shows the result of electrophoresis. Lane 1 is pUC19/HpaII as DNA size markers (reported as base pair (bP)), and the size of each band is indicated on the left of the gel photograph (FIG. 20). Lane 2 and 3 shows that exon 2 (343 bp) and exon 1 (184 bp) were successfully amplified. Lane 4 shows that full-length cDNA of human luteinizing hormone (503 bp) was obtained. Lane 5, 6, and 7 are the control samples that contains the same substance as lane 2, 3, and 4 except the template DNA, and do not show any non-specifically amplified products. From this result, it was proved that this technology can be used to obtain full-length cDNA from genomic DNA in one tube and by one step PCR with primers supported on said material.

The entire disclosure of Japanese Patent Application No. 2001-291249 filed on Sep. 25, 2001 including specification, claims, drawings and summary is incorporated herein by reference in its entity.

All publications, patents and patent applications cited herein are incorporated herein by reference in their entity.

INDUSTRIAL APPLICABILITY

In accordance with the present invention, printed materials comprising at least one support having at least one oligomer and/or polymer applied thereon are provided. Scientists can obtain oligomers and/or polymers of interest from the printed materials easily and immediately.

In accordance with the present invention, a method for delivering or storing at least one oligomer and/or polymer is provided. By this method, oligomers and/or polymers can be delivered and stored easily with reduced labor and time while eliminating the need to use special equipment or facilities.

Free Text of Sequence Listing

SEQ ID NO.1 shows the base sequence of M13 primer used in Example 1.

SEQ ID NO. 2 shows the base sequence of RV32 primer used in Example 1.

SEQ ID NO.3 shows the base sequence of the template DNA used in Example 1.

SEQ ID NOS: 4-6 show the sequences of the three cDNA mouse clones tested in Examples 3-7.

SEQ ID NO:7 shows the sequence of -21M13 primer used for the amplification of DNA of Example 3-7.

SEQ ID NO:8 shows the sequence of 1233-RV primer used for the amplification of DNA of Example 3-7.

SEQ ID NO: 9 is the sequence of the full-length human luteinizing hormone gene (cDNA) obtained in Example 8.

SEQ ID NOS: 10-11 show the sequences of exon 1 and exon 2, respectively, of the human luteinizing hormone (hLH).

SEQ ID NOS:12-15 shows the sequences of primers HSLH1F, HsLH1Rt, HsLH2Ft, HsLH2R for the amplification of the two exons of hLH and for the synthesis of hLH full-length.

1. A printed publication material comprising at least one support attached, added and/or included to the printed publication material, the support having at least one oligomer and/or polymer applied thereon.

2. The material of claim 1, which is in unbound form.

3. The material of claim 1, which is in bound form.

4. The material of claim 3, wherein the support is not bound in the material.

5. The material of claim 3, wherein the support is bound as a page of the bound material.

6. The material of claim 1, comprising at least two supports which are not bound together.

7. The printed material of claim 1, wherein said printed material comprises at least one printed page.

8. The material of claim 1, wherein the printed material is selected from the group consisting of journals, magazines, articles, books, booklets, leaflets, pamphlets, reports, posters, cards and labels.

9. The material of claim 1, wherein the support is a water-unsoluble, water-dissolvable and/or water-soluble support.

10. The material of claim 9, wherein said water-unsoluble support comprises cellulose as a major component.

11. The material of claim 9, wherein said water-soluble support is in the form of a wafer.

12. The material of claim 1 wherein said support is in the form of card(s).

13. The material of claim 1, wherein the oligomer is selected from the group consisting of oligonucleotide, oligopeptide, oligosaccharide, PNA and a mixture thereof.

14. The material according to claim 1, wherein the polymer is selected from the group consisting of polynucleotide, polypeptide, polysaccharide, PNA and a mixture thereof.

15. The material of claim 1, wherein the oligomer or polymer is a fragment or a complete molecule.

16. The material of claim 13, wherein said oligonucleotide is selected form the group consisting of genomic DNA, cDNA, RNA, mRNA, PNA and a combination thereof.

17. The material of claim 16, wherein said oligonucleotide of is selected form the group consisting of a fragment, an EST sequence, a long strand, a full-coding and a full-length sequence.

18. The material according to 13, wherein the oligonucleotide comprises one or more amplification and/or ligation primer and/or oligonucleotide probe(s).

19. The material according to claim 18, comprising a set of primers for the amplification and ligation of exons of a gene comprised in genomic DNA.

20. The material of claim 19, wherein the set of primers comprises a pair of primers for each exon of the desired gene, at least one primer of each pair of one exon being also partially complementary to the next exon.

21. The material of claim 20, wherein the set of primers are suitable for synthesizing cDNA and/or full-length cDNA from genomic DNA by amplification and ligation of the exons of a gene.

22. The material according to claim 1, further comprising one or more enzymes and/or buffer.

23. A method for preparing a printed publication material comprising: providing at least one support attached, added and/or included to the printed material, the support having at least one oligomer and/or polymer applied thereon; applying the oligomer and/or polymer on the support; and attaching, adding and/or including the support to the printed material before or after printing.

24. The method of claim 23, wherein the oligomer and/or polymer is applied on the support by fixing or printing it on the support.

25. The method of claim 23, wherein the oligomer is selected from the group consisting of oligonucleotide, oligopeptide, oligosaccharide, PNA and a mixture thereof and the polymer is selected from the group consisting of polynucleotide, polypeptide, polysaccharide, PNA and a mixture thereof, and the support is a water-unsoluble, water-dissolvable and/or water-soluble support.

26. A method for delivering and/or storing at least one oligomer and/or polymer applied on at least one support for a printed material, comprising: 1) applying the oligomer and/or polymer on the support before or after printing; and 2) delivering or storing the printed material.

27. The method of claim 26, wherein the oligomer and/or polymer is applied on the support by applying or adhering a solution of the oligomer and/or polymer directly to the support by a pin, syringe or ink-jet printer.

28. The method of claims 26, wherein the oligomer is selected from the group consisting of oligonucleotide, oligopeptide, oligosaccharide, PNA and a mixture thereof and polymer is selected from the group consisting of polynucleotide, polypeptide, polysaccharide, PNA and a mixture thereof, and the support is a water-unsoluble, water-dissolvable and/or water-soluble support.

29. The method of claim 23, further comprising: recovering the oligomer and/or polymer by elution from the support.

30. The method of claim 29, wherein the recovering is carried out by inserting the support in a device and performing the elution and recovery from the support automatically by the device.

31. The method of claim 30, wherein the support is in the form of card.

32. The method of claim 31, wherein the card comprises a bar-code, a chip or a label containing information about the position of the oligomer and/or polymer on the card.

33. The method of claim 23, wherein an operator selects the oligomer and/or polymer of interest and the device automatically elutes and recovers the oligomer and/or polymer of interest from the support.

34. A method for synthesis of cDNA comprising the steps of: a) applying at least a set of primers for the amplification and/or ligation of exons of a support and/or printed material, b) recovering the at least set of primers from the support and/or printed material, c) mixing the set of primers with template DNA, enzyme and buffer and carrying out the amplification and/or ligation.

35. The method of claim 34, wherein after step a) the support and/or printed material is stored and/or delivered.

36. The method of claim 34, wherein the enzyme and buffer are applied on the support and/or printed material during step a).

37. The method of claim 34, wherein the product of amplification and/or ligation is cDNA and/or full-length cDNA.

38. The method of claim 37, wherein the cDNA and/or full-length cDNA is recovered and used for determination of nucleotide insertion/deletion, SNP and sequencing analysis.

39. The method of claim 37, wherein the cDNA and/or full-length cDNA is recovered and used for the peptide, polypeptide or protein expression.

40. The method of claim 38, which is a diagnostic method for determination of nucleotide insertion/deletion, or SNP analysis.

41. A kit comprising a support and/or printed material comprising at least one primer or a set of primers applied thereon.

42. The kit of claim 41, wherein the support and/or printed material further comprising at least one of enzyme, buffer, genomic DNA, cDNA, RNA, mRNA, PNA, plasmid, vector and nucleic acid.

43. A kit for the synthesis of cDNA and/or full-length cDNA from genomic template, comprising at least one support and/or printed material comprising at least one set of primers, for the amplification and/or ligation of exons, applied thereon.

44. The kit of claim 43, further comprising at least one enzyme for the amplification and/or ligation step, and/or buffer.

45. The material of claim 14, wherein said polynucleotide is selected form the group consisting of genomic DNA, cDNA, RNA, mRNA, PNA and a combination thereof.

46. The material of claim 14, wherein said polynucleotide is selected form the group consisting of a fragment, an EST sequence, a long strand, a full-coding and a full-length sequence.

47. The material according to claim 14, wherein the polynucleotide comprises one or more amplification and/or ligation primer and/or oligonucleotide probe(s).

48. The method of claim 27, wherein the oligomer and/or polymer, and the support is as defined in claim 1.

49. The method of claim 26, further comprising: recovering the oligomer and/or polymer by elution from the support.

50. The method of claim 26, wherein an operator selects the oligomer and/or polymer of interest and the device automatically elutes and recovers the oligomer and/or polymer of interest from the support.

51. The material of claim 25, wherein the oligomer or polymer is a fragment or a complete molecule.

52. The material of claim 25, wherein said oligonucleotide or polynucleotide is selected form the group consisting of genomic DNA, cDNA, RNA, mRNA, PNA and a combination thereof.

53. The material of claim 25, wherein said oligonucleotide or polynucleotide is selected form the group consisting of a fragment, an EST sequence, a long strand, a full-coding and a full-length sequence.

54. The material according to 25, wherein the oligonucleotide or polynucleotide comprises one or more amplification and/or ligation primer and/or oligonucleotide probe(s).

55. The material according to claim 54, comprising a set of primers for the amplification and ligation of exons of a gene comprised in genomic DNA.

56. The material of claim 55, wherein the set of primers comprises a pair of primers for each exon of the desired gene, at least one primer of each pair of one exon being also partially complementary to the next exon.

57. The material of claim 56, wherein the set of primers are suitable for synthesizing cDNA and/or full-length cDNA from genomic DNA by amplification and ligation of the exons of a gene.

58. The material of claim 28, wherein the oligomer or polymer is a fragment or a complete molecule.

59. The material of claim 28, wherein said oligonucleotide or polynucleotide is selected form the group consisting of genomic DNA, cDNA, RNA, mRNA, PNA and a combination thereof.

60. The material of claim 28, wherein said oligonucleotide or polynucleotide is selected form the group consisting of a fragment, an EST sequence, a long strand, a full-coding and a full-length sequence.

61. The material according to 28, wherein the oligonucleotide or polynucleotide comprises one or more amplification and/or ligation primer and/or oligonucleotide probe(s).

62. The material according to claim 61, comprising a set of primers for the amplification and ligation of exons of a gene comprised in genomic DNA.

63. The material of claim 62, wherein the set of primers comprises a pair of primers for each exon of the desired gene, at least one primer of each pair of one exon being also partially complementary to the next exon.

64. The material of claim 63, wherein the set of primers are suitable for synthesizing cDNA and/or full-length cDNA from genomic DNA by amplification and ligation of the exons of a gene.
